(19) United States
(12) Patent Application Publication
(10) Pub. No.: US 2002/0158812 A1
(43) Pub. Date: Oct. 31, 2002

(54) Phone handset with a near-to-eye microdisplay and a direct-view display

(76) Inventor: Matthew G. Pallakoff, Mountain View, CA (US)

Correspondence Address: GARY CARY WARE & FREIDENRICH LLP, 1755 EMBARCADERO ROAD, PALO ALTO, CA, 94303-3340, US

(21) Appl. No.: 10/113,772

(22) Filed: Apr. 1, 2002

Related U.S. Application Data
(60) Provisional application No. 60/280,770, filed on Apr. 2, 2001.

(51) Int. Cl. G09G 5/00

(52) U.S. Cl. 345/5

(57) ABSTRACT

This invention provides a hand-held electronic device that enables users to comfortably view large high-resolution content on the device while still being able to easily interact with that content and with the device's other functions. The device includes two displays in the device. One is a microdisplay for viewing the large high-resolution images when the microdisplay is held near the eye, and a traditional “direct-view” display like those found on most cell phones today for viewing lower resolution text or images when the phone handset is held at normal or arms' length reading distance. The two displays should be positioned close to one another and in the same line of sight, so that transitioning between near-to-eye viewing of the microdisplay and arms'-length viewing of the direct-view display is a simple matter of moving the device nearer or further from the eye in a straight line.

### RELATED APPLICATIONS

This application claims priority, under 35 USC §120, from US Provisional Patent Application No. 60/280,770, filed on Apr. 2, 2001.

### BACKGROUND OF THE INVENTION

The invention generally relates to hand-held communication and computing devices. More specifically, the invention relates to hand-held communication and computing devices, including cellular phones, smart-phones, Web-phones, PDAs, hand-held computers, and other hand-held devices, that have two displays -a direct-view display (such as the displays built into most cellular phones today) for viewing relatively low-resolution text or images, and a microdisplay that uses magnifying optics to display images that, when the microdisplay is held near a user's eye, can appear larger and higher resolution than images shown on a direct-view display of approximately the same width and height.

Inviso Inc. and other companies have developed microdisplay technologies that manufacturers can embed into (or attach to) pocket-sized devices to allow users to see full-screen, high-resolution images on those small devices. Microdisplays are tiny electronic displays combined with magnifying optics. When a microdisplay is held near a user's eye (typically between 0.5 and two inches from the eye), the user can see a large, high-resolution image. Other documents may use the term “microdisplay” to refer just to the tiny display, without the lenses, prisms, and other optical elements that magnify the image. This patent will use the term “microdisplay” to refer to the combination of the tiny display and the optical elements that magnify the display's image. Combined, these elements form a display module that is typically about one to two inches square and approximately an inch thick. For example, with Inviso's 3430 Optiscape microdisplay, a user can see an 800×600-pixel color image that appears approximately the same size as a 45-inch computer monitor six feet away. This is approximately the same apparent size as a 19″ monitor 2.5 feet away, but Inviso's optics allow the user's eyes to focus six feet away, which is more relaxing than focusing up close. Inviso has patents covering many aspects of Inviso 's microdisplay technologies. The present patent discusses new inventions related to devices with multiple displays, including devices with both a microdisplay and a direct-view display.

One of the most limiting constraints associated with today's cellular phones and other pocket-sized communication and computing devices is their displays' small size and resolution. For example, even the best displays on current cell phones are still too small and too low resolution to display a regular Web page or other application document in a form that a user can easily recognize, read, navigate, and interact with—the way a user can on a desktop or notebook computer (using a desktop monitor or notebook display). Manufacturers could use wider and taller displays in their devices, but only by making the devices larger—which tends to make the devices less appealing to consumers.

A great way to overcome the small-display constraint on small devices is to embed microdisplays in those devices. With appropriate embedded software for rendering full-screen images on those microdisplays, similar to rendering software used on desktop computers, users can then see full-screen, high-resolution images by bringing the microdisplay near to their eye. Inviso has developed a pocket-sized hand-held computer with an embedded microdisplay, as proof-of-concept that such a device can be made. The device, called “eCase”, won the 2000 SID Information Display Magazine “Display Product of the Year Gold Award”.

Using a microdisplay on a small device allows users to view large high-resolution images despite the device's small size. However, if the only display on a device is a microdisplay, then users must hold the microdisplay near their eye to use most of the device's functions. As Inviso learned from eCase, this makes it awkward to input text and hard to use many of the functions on the device—partly because it is hard to see buttons and controls on the device when holding it an inch or two from the eye, and partly because users simply are not used to interacting with devices while holding them close to their eye. In addition, if the microdisplay is the only display on the device, then the microdisplay must remain on all the time the user is using the device. Currently, high-resolution microdisplays (particularly color microdisplays) typically consume more power than standard displays found on cell phones and PDAs today, so leaving the microdisplay on all of the time will drain the device's battery relatively quickly.

Some companies have experimented with attaching a microdisplay on a pivot at the base of a mobile phone, to allow users to view video clips while holding the phone to their ear. Others have proposed attaching a microdisplay to the side of a phone. These phones have also included a traditional “direct-view” display like those found on most cell phones today for viewing lower resolution text or images when the phone handset is held at normal reading distance (typically 1-2 feet away, which we will call “arms'-length” viewing for the purposes of this patent). However, the designs of these devices do not facilitate close coordination between content displayed on the microdisplay and content displayed on the direct-view display: They are designed primarily for viewing one type of content on the microdisplay (such as video clips or Web pages), and viewing unrelated types of content on the direct-view display (such as phone numbers and phone settings). When viewing the type of content designed for the microdisplay, the microdisplay must remain on continuously—typically consuming more power than the direct-view display. More importantly, with those designs, the microdisplay and primary direct-view display are not in the same line of sight and not oriented in the same direction, so transitioning between viewing the microdisplay near-to-eye and viewing the direct-view display at arms'-length is awkward—requiring the user to rotate or spin the device at least 90 degrees while transitioning between near-to-eye and arms'-length viewing. (For example, a phone designed with a microdisplay attached on a hinge or swivel at the bottom—so that a person can look into the microdisplay while holding the phone to the person's ear—requires the person to rotate and spin the phone as the person moves the phone from close to the person's ear and eye out to arms'-length viewing of the direct-view display in front of the person's eyes. The images on the two displays are oriented 90-degrees differently.) Interacting with content on the microdisplay on these devices typically requires operating buttons or controls in awkward ways, or holding the device differently than when interacting with content on the direct-view display. For example, on a device with a microdisplay attached to a pivot at the bottom, moving a cursor displayed on the image in the microdisplay typically requires operating a cursor control with a thumb or other finger that is on the hand holding the device near the users ear: It feels awkward to operate a cursor control with a finger near the ear. All of these design characteristics introduce a form of “cognitive dissonance” (an unpleasant state of tension experienced by the user), particularly as the user transitions between near-to-eye use of the device and arms'-length use of the device. Similarly, it is difficult to type text into an editable text field on a Web page while viewing that page on a microdisplay held near-to-eye.

### SUMMARY OF INVENTION

If a manufacturer wants to enable users to comfortably view large high-resolution content on a small device—while still being able to easily interact with that content and with the device's other functions—then the manufacturer should include two displays in the device: A microdisplay for viewing the large high-resolution images (when the microdisplay is held near the eye), and a traditional “direct-view” display (like those found on most cell phones today) for viewing lower resolution text or images when the phone handset is held at normal reading distance (i.e. arms'-length). And when a user is transitioning between using one display and the other, the two displays should be positioned close to one another (preferably separated by an inch or less), and in the same line of sight, so that transitioning between near-to-eye viewing of the microdisplay and arms'-length viewing of the direct-view display is a simple matter of moving the device nearer or further from the eye in a straight line, requiring little or no tilting of the device forward or backward, and requiring no spinning or sideways rotation (e.g. clockwise or counterclockwise) of the device. This patent describes several preferred embodiments of phone handsets, each of which includes both a microdisplay for near-eye viewing and a direct-view display for arms' length viewing, as well as several related inventions for making great microdisplay-enhanced devices.

An important common characteristic of these preferred embodiments is that they are designed to facilitate a seamless, natural transition between near-to-eye viewing of content on the microdisplay and arms' length viewing of content on the direct-view display. In particular, they are designed to work well with software on the device that intelligently coordinates images displayed on the microdisplay and images displayed on the direct-view display. For example, if the user is viewing a Web page on the microdisplay held near-to-eye, they should be able to position a cursor (or some other indication of a region of interest) on a particular part of the Web page, then move the device out to arms'-length and view that region of interest on the direct-view display (i.e. view a subset of the overall web page on the direct-view display). If that region of interest includes an editable text box, the user should be able to type into that editable text box while holding the device at arms'-length—which is typically easier than typing text on a device held near-to-eye. In addition to these ergonomic benefits, another key benefit of enabling comfortable arms'-length viewing of content on the direct-view display of portions of content that appear on the microdisplay is that the microdisplay can be turned off whenever the user is holding the device at arms'-length (since the microdisplay is only useful near-to-eye): This allows the device to save considerable power, relative to leaving the microdisplay on all the time whenever high-resolution content is being viewed.

The usage model facilitated by this invention, as described above, mirrors what happens when a person uses a desktop monitor: Typically a person briefly “takes in” the entire display (i.e., looks at the entire image without focusing on a specific region of the display at first), and then focuses in on a specific region of interest (such as text they want to read, or a text-insertion point where they want to type, or some other item of interest). This invention allows microdisplay-enhanced devices to model this behavior. And this invention enables better ergonomic characteristics and better power-consumption characteristics than previous designs for microdisplay-enhanced devices.

### BRIEF DESCRIPTION OF THE DRAWINGS:

FIG. 1A is a side view of a microdisplay-enhanced handset.

FIG. 1B is a front view of a microdisplay-enhanced handset.

FIG. 1C is a front view of a microdisplay-enhanced handset, held in a person's hand.

FIG. 2A is a side view of a flip-style handset with both a direct-view display and a microdisplay.

FIG. 2B is a front view of a flip-style handset with both a direct-view display and a microdisplay.

FIG. 2C is a front view of a flip-style handset with both a direct view display and a microdisplay, held in a person's hand.

FIG. 3A is a side view of an alternative configuration for a handset with both a microdisplay and a direct-view display.

FIG. 3B is a front view of an alternative embodiment for a handset with both a microdisplay and a direct-view display.

FIG. 3C is a front view of an alternative configuration for a handset with both a microdisplay and a direct-view display, held in a person's hand.

FIG. 4 is an illustration of a handset with two displays and with buttons for highlighting and selecting selectable items on a list of selectable items displayed on one of the displays.

FIG. 5 is a front view and a side view of an alternative configuration for a handset with an embedded microdisplay that is in a tilted position.

FIGS. 6A, 6B, and 6C are front views showing an alternate configuration for a handset with a microdisplay that, when not in use, folds into the body of the handset.

FIG. 7 is a front view of an alternative embodiment for a handset wherein one microdisplay swings out from one side of the handset on a pivotal arm and a second microdisplay is embedded in the device.

FIG. 8A is a front view and a side view of an alternate embodiment for a handset having two embedded microdisplays and a direct-view display that is large relative to each microdisplay.

FIG. 8B is a top view of the embodiment whose front view is shown in FIG. 8A, with the front of the device facing down.

FIGS. 9A, 9B and 9C are front views of alternative embodiments for a handset having a microdisplay in a detachable module.

FIG. 10A is a front view of an alternative embodiment for a handset with a microdisplay that, when not in use, slides into the body of the handset.

FIG. 10B is a front view of the handset of FIG. 10.A, with the microdisplay extended for use.

FIG. 10C is a side view of the handset of FIGS. 10.A and 10.B, with the microdisplay retracted (i.e. slid into the body of the handset).

FIG. 10D is a side view of the handset of FIGS. 10A through 10C, with the microdisplay extended for use.

### DETAILED DESCRIPTION OF PREFERRED EMBODIMENTS

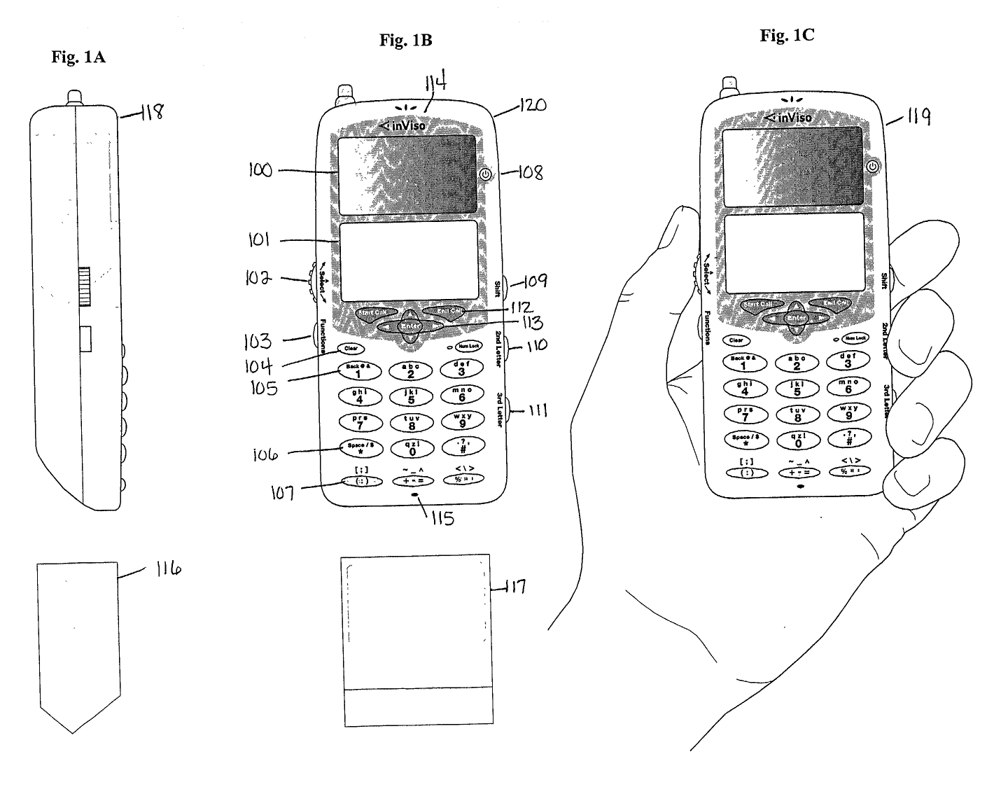

FIG. 1A shows a microdisplay-enhanced handset 118 in side-view. FIG. 1B shows the same in front-view. FIG. 1C shows the same in front-view, shown held in a person's hand. This handset includes a microdisplay 100 positioned above a direct-view display 101. Most of the elements of this handset could be applied to a wide range of devices—including cellular phones, “Smart-phones”, Web-phones, PDAs, hand-held computers, remote controls, and others. Throughout the rest of this patent, most references to “handsets” can refer to any of these types of devices.

The direct-view display can be any kind of direct-view display, but preferably it would be a thin bit-map TFT LCD display with less resolution than the microdisplay but enough to render an identifiable portion of a larger image. For example, a 160×120-pixel direct-view display with 3-bits of gray scale (white, black, and six intensities of gray in-between white and black) would be sufficient for displaying text, simple graphics, and portions of Web pages, while still keeping the cost of the direct-view display relatively low. If the microdisplay can display color images, then preferably the direct-view display would be color too—so that it can accurately display portions of images that appear on the microdisplay.

Below the side-view of FIG. 1A and the first front-view illustrations of the handset in FIG. 1B are side-view 116 and front-view 117 illustrations of Inviso's 3430 Optiscape microdisplay module which includes electronics and optics—just to illustrate their size relative to the overall handset. Many other elements on this handset are common on cell phone handsets today such as the speaker 114, a power on/off button 108, a microphone 115, “Start Call” and “End Call” buttons 112.

In FIGS. 1A, 1B, and 1C, the microdisplay module shapes shown are only examples. The shapes shown in these figures approximately represent the shape of Inviso Inc.'s “Optiscape II 3430” microdisplay module. But microdisplay modules can be manufactured in a wide range of shapes and sizes. Furthermore, as an alternative to embedding a pre-assembled microdisplay module, a microdisplay-enhanced handset (or other device) could be manufactured by separately assembling into the device all of the electronics and optics that one finds in pre-assembled microdisplay modules (such as Inviso's Optiscape 3430 module). This invention is independent of the shape of the microdisplay components or the method of assembling microdisplay components into the device.

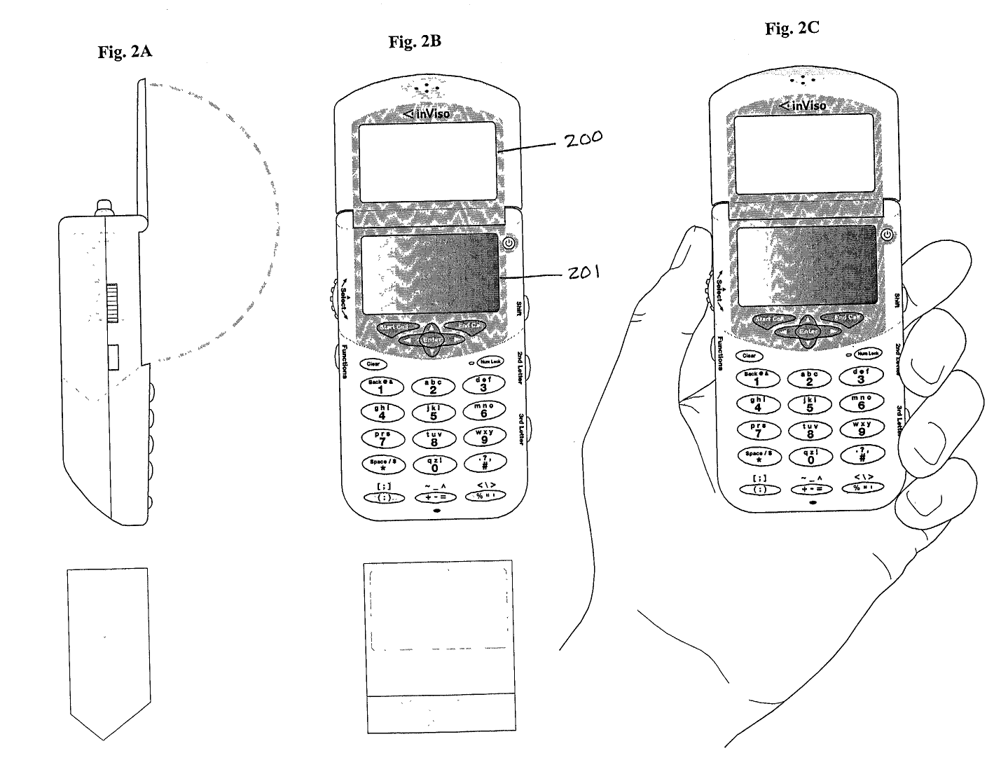

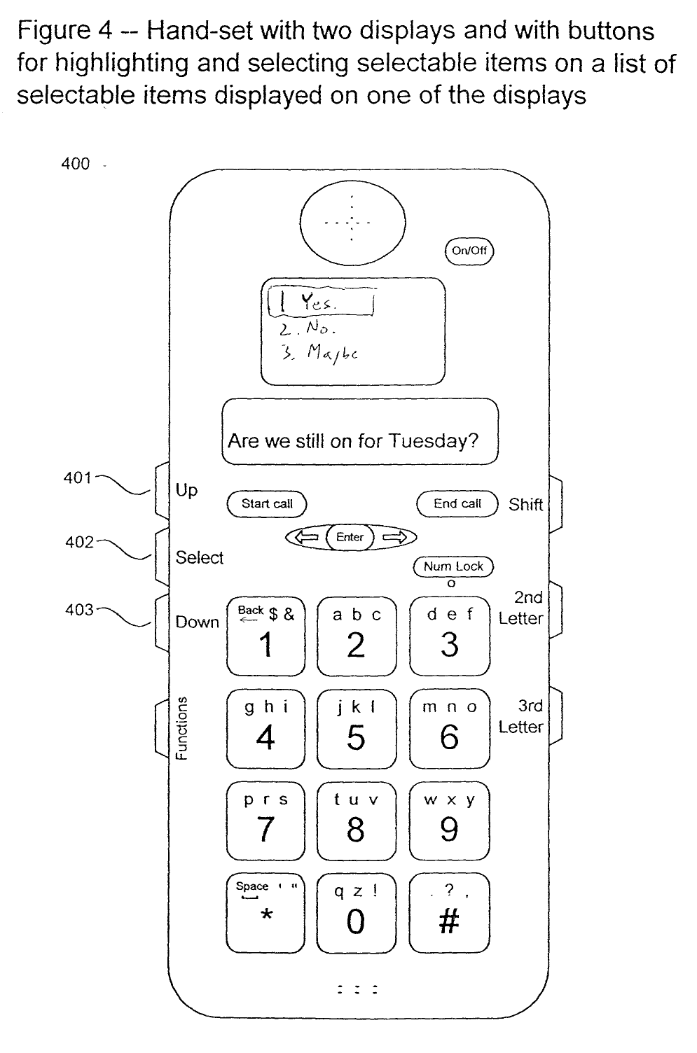

Handset users frequently interact with various functions supported on the handset, such as instant messaging, email, contact management, dialing from a list of contacts, calculator, Web browsing, and so on. To interact with those functions, users need to see (or hear) feedback as they use the functions. For example, when typing an instant message, a user needs to see the text the user is typing to know that it's being typed correctly. For most functions, including instant messaging, the feedback presented by the handset is relatively simple and brief—capable of being expressed in a few lines of text or in a small low-resolution bit-mapped display. On handsets built according to this invention, relatively simpler or brief feedback should usually be presented on the direct-view display 100 of FIG. 1B, as is done on a traditional handset that has only a direct-view display. This allows users to see the feedback while holding the handset at arms' length (as opposed to near-to-eye) so they can still easily see and operate the handset's buttons and other controls. But when a function involves viewing or interacting with a large image, such as a Web page, a spreadsheet, or a high-resolution document attached to an email, then a handset built according to this invention should allow users to view that image on the microdisplay 101 of FIG. 1B. The direct-view display and the microdisplay are located adjacent each other in FIG. 1, as is also the case in FIGS. 2 and 4, so as to allow coordination of images as set forth in co-pending patent application Ser. No.______. There could be other small components between the two displays, such as a telephone speaker, LEDs, and/or distance sensing components. But the two displays should be close to one another (preferably separated by an inch or less), and they should be in the same line of sight (with the microdisplay optionally tilted back slightly), so that, as described above and in the patent referenced in this paragraph, users can easily and seamlessly transition between looking into the microdisplay near to the eye and viewing the direct-view display at regular reading distance.

While different handsets can differ in what they display on the two displays (the microdisplay 101 and the direct-view display 100), in general designers should strive to allow users to interact with the handset's functions while viewing the direct-view display. That makes it easier to see and operate more of the device's buttons and controls (e.g. for typing or for navigating through the functions' features) as compared to holding the device near-to-eye. Of course, designers can also allow users to interact with functions while holding the device near-to-eye and using the microdisplay by designing the handset so it displays some feedback on the microdisplay (instead of, or in addition to, displaying that feedback on the direct-view display).

In our first preferred embodiment, the microdisplay is near the top of the device, so that the user can hold the lower part of the device in their hand and bring it near-to-eye—similar to the way a person typically holds a large magnifying glass by the handle and brings it near-to-eye. This feels a little less awkward to most people than bringing the bottom part of a device (or the side of a device) near-to-eye. With a one-piece handset such as the one illustrated in FIG. 1, there are two advantages to placing the microdisplay near the top of the handset and placing the direct-view display in the middle of the phone (above the keypad). First, it makes it easier for the user to bring the microdisplay close to the eye, as compared to placing the microdisplay in the middle or at the bottom of the handset. Second, it places the direct-view display (where feedback for most text being typed would be presented) near the keyboard (so the user does not have to move their eyes far from the typing keys to the display showing the feedback).

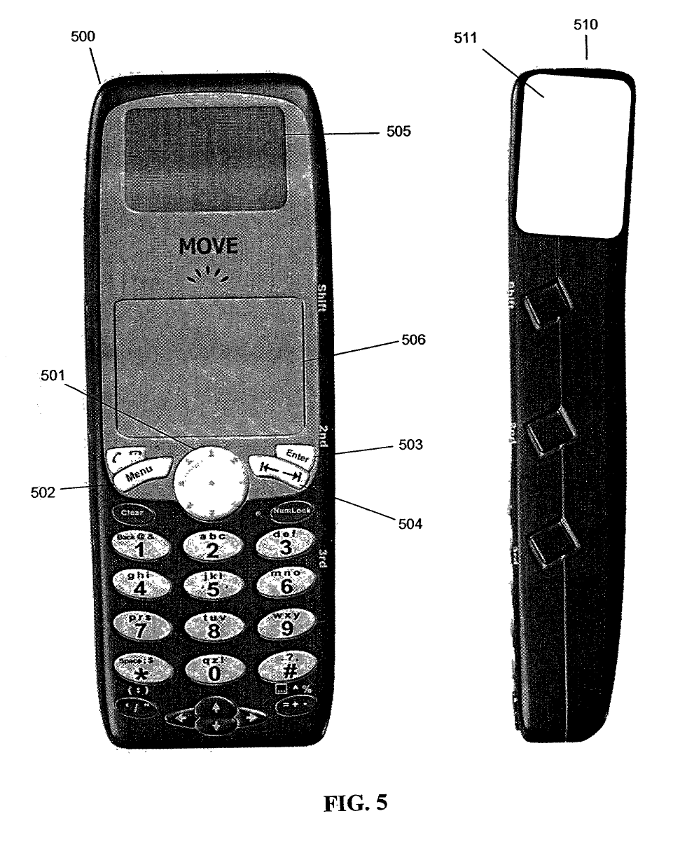

FIG. 5 shows another mobile phone design using this preferred embodiment in front view 500 and side-view 510, with an embedded microdisplay 511 represented by the light colored rectangle near the top of the side-view. A device built according to this preferred embodiment should slightly tilt the microdisplay module 511 back, relative to the rest of the phase of the device. This will allow a user to hold the microdisplay near-to-eye, holding the device in one hand, with the thumb of that hand placed lower on the face of the device (for example, on a cursor control just below the direct-view display) while tilting the device slightly toward their forehead, so their thumb does not have to touch their face, and while still being able to look straight into the microdisplay module to see the image clearly.

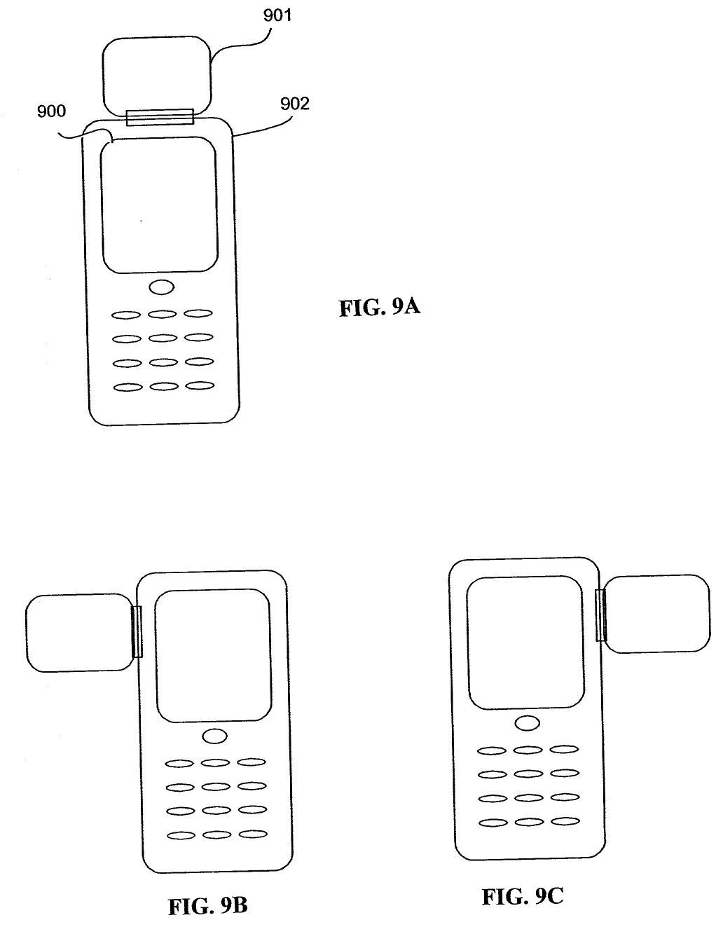

In a preferred embodiment, the microdisplay is embedded in the device as shown in FIG. 1. But a reasonable alternative that preserves the benefits of the first preferred embodiment described above and illustrated in FIG. 1, is seen in FIGS. 9A through 9C. In FIG. 9A the microdisplay 901 is in a separate module that can easily be attached or detached to the top (or to the top-left or top-right edge) of a device 902 that includes a direct-view display 900 and all of the other elements shown in FIG. 1 except for the microdisplay. This would allow the user to leave the microdisplay module attachment 901 in their pocket or purse (or at home) if they know they aren't going to use it for a while, making the rest of the device smaller. In general, producing a device and a separate attachment to hold the device will cost more than producing an all-in-one device, because of the extra plastics and assembly. Attaching the microdisplay to the top, top-left edge, or top-right edge of the device as shown in FIGS. 9a, 9b, and 9c is preferable to attaching the microdisplay to the bottom of the device, for the reasons outlined in the previous paragraph.

The device can also be designed such that depressing a given button on the device (or depressing a combination of one or more buttons or controls) results in the device popping up and displaying (on one or more displays) one of the menus in a menu bar associated with the device or with the front window on the device (such as the “File” menu at the top left of documents on most PC documents) while concurrently highlighting the top menu item in that menu. In a preferred embodiment, a button simply named “Menu” would bring up this menu. Then depressing left or right arrow buttons on the device (or the left or right side of a cursor control, or tab-backward/tab-forward buttons, other bi-directional buttons or controls), such as those in control 113 on FIG. 1, could close the currently popped-up menu and cause the previous or next menu in the menu bar to pop up with the top item on that menu highlighted. Further, the device could be designed such that further depressing up or down arrows on the device (or the top or bottom sides of a cursor control, or other up/down controls), such as those in control 113 on FIG. 1, highlights the next or previous menu item in the currently popped up menu. At that point, pressing an “enter” or “select” button on the phone results in the highlighted menu item being selected. Note that controls for navigating menus (and the controls for moving a cursor) can appear on the side of the device or on the front of the device.

The device can further be designed such that spoken commands via speech recognition software can be used to pop up and traverse menus or to select menu items; and in which the device's speech recognition features are enabled only when the user holds in a button designed for that function on the device. In a preferred embodiment of such a hand-held device, this “push-to-talk” button could be on the side of the device where a user could depress it with a finger or thumb on the hand holding the device. The push-to-talk button could alternatively appear on the front of the device.

FIG. 2A through FIG. 2C illustrate a flip-style handset with both a direct-view display 200 and a microdisplay 201. Microdisplays are relatively thick (because of their magnifying optical elements) and direct-view displays are relatively thin (since they do not require magnifying optical elements). So a preferred embodiment of a flip-style phone would place the direct-view display on the thin part of the phone that flips away from the main body of the phone. In FIG. 2B, this is the top part of the phone. A flip-style phone could also be designed in which the keyboard and the direct-view display are on a relatively thin bottom part of the phone, and the microdisplay is on a relatively thick top part of the phone that flips up—but that would tend to make the phone feel top-heavy.

A preferred embodiment of this invention would include a distance sensor that would be used to automatically turn on the microdisplay and turn off the direct-view display when the user brings the microdisplay near-to-eye (e.g. within a few inches) when the device has content to display on the microdisplay, and otherwise automatically turn off the microdisplay off and turn on the direct-view display.

It can be a bit uncomfortable for some people to use one eye to look into a microdisplay while closing the other eye (to avoid seeing other images in the background). So to allow users to keep the other eye open, Inviso included an “occluder” on their eCase device. The occluder was simply a piece of plastic that covered the microdisplay when not in use, and which the user could open up to reveal the microdisplay and to serve as a shield that blocks the view of the other eye when the first eye is looking into the microdisplay. The occluder is a medium or dark gray color, so the user could keep both eyes open without light from the occluded eye interfering with the image seen by the eye that is looking into the microdisplay. Embodiments of this invention could a sliding or pivoting opaque part that covers the microdisplay when the device is off (or when the user does not intend to use the microdisplay), but that then slides or pivots open to uncover the microdisplay and to serve as an occluder when the user is using the microdisplay.

In addition, a device can include a switch that detects whether the occluder/cover is open or closed, so that, when the occluder/cover is closed and covering the microdisplay, the microdisplay will never turn on, even if the distance sensor discussed earlier indicates that the user's eye is near. This can help assure that the microdisplay does not go on if the user puts the device in their pocket or purse, or face down on a table, while the device has content to display on the microdisplay.

Alternatively, a device can automatically open or close the occluder when the distance sensor senses that the user is holding the device near-to-eye. If this is implemented, the occluder should open sideways—rather than swinging forward, since it might touch the user's eye when swinging forward. And it should open with very little force and have blunt edges (not sharp edges) so as not to hurt a person's eye if the user accidentally holds the device in a position where the occluder opens automatically.

Of course, a device maker could also choose to make a microdisplay-enhanced device without a distance sensor that simply used the occluder/cover open/close detection switch to turn the microdisplay on and off: When the user opens the occluder, the microdisplay would go on (if the device has content to display on it). Otherwise the microdisplay would turn off. But using a distance sensor would generally be more power-efficient, since the microdisplay could remain off when the user isn't holding the device near-to-eye even when the occluder/cover is open.

Similarly, a device maker could simply use a microdisplay on/off button (e.g. operated by the user's thumb or other finger) to allow the user to manually turn the microdisplay on or off.

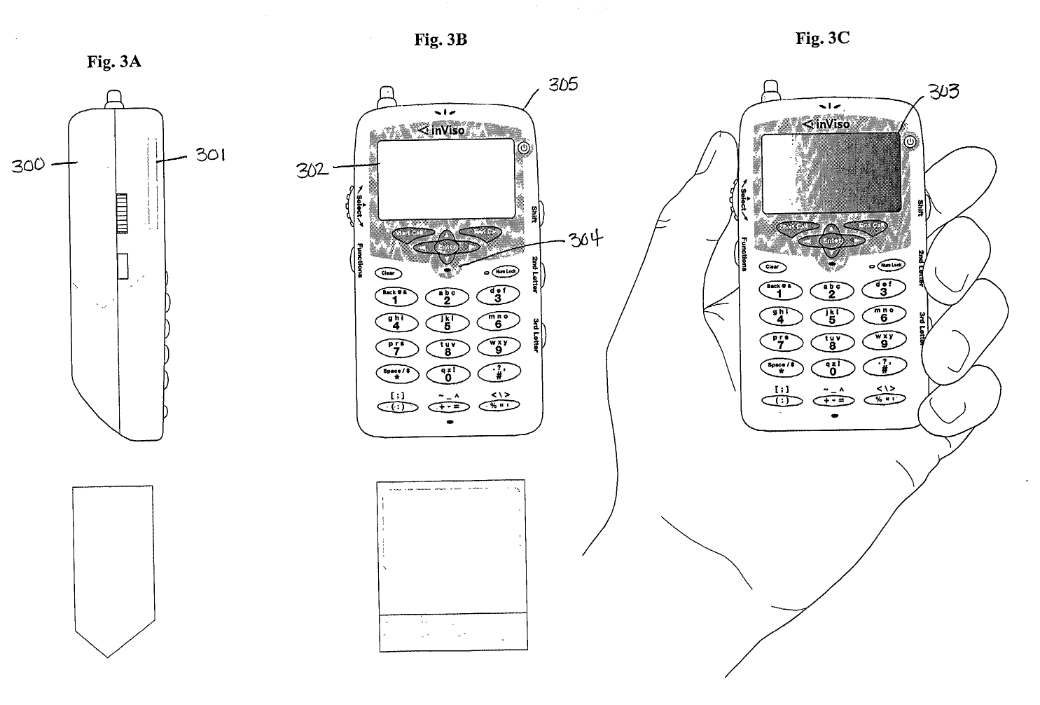

FIG. 3A through FIG. 3C illustrate a compelling alternative configuration for a handset with both a microdisplay 300 and a direct-view display 301 as seen in the side-view representation of FIG. 3A. In this embodiment, a special type of direct-view display capable of turning transparent is placed directly over the microdisplay. For example, certain types of OLED displays can be built on transparent materials. As with the designs described above, for most functions (placing a phone call, scrolling through lists of contacts, and instant messaging, for example) the user simply uses the direct-view display for feedback, since the feedback consists of relatively low-resolution text or images. In these instances, when the user looks at the front of the phone 305 in FIG. 3B, he or she sees the relatively low-resolution text or images on the direct-view display 302. But when the user decides to view an image or document that is best viewed on full-screen, high resolution displays (Web pages, excel spread-sheets, large photos, etc.) then the handset would display that image or document on the microdisplay. A handset can be designed to have a button (or other control) that the user uses to make the direct-view display become transparent (and to turn the microdisplay on) so the user can see through to the microdisplay. But a preferred embodiment would include a distance-sensor 304 in FIG. 3B that automatically senses when the user's eye is close to the microdisplay (within a few inches) and then automatically makes the direct-view display transparent (302 in FIG. 3A and FIG. 3B) and turns on the microdisplay (300 in FIG. 3A and 303 in FIG. 3C) so the user can see through the direct-view display 301 to the image presented by the microdisplay 300. Various distance-sensing technologies—including ultrasonic distance sensors and infrared distance sensors—are used in current digital video cameras, still cameras, and other electronic devices. For example, the Sony Mavica MVC CD1000 digital still camera has both a direct-view display on its back and a separate mid-resolution microdisplay in its viewfinder, and it includes a distance sensor so that when a user puts their eye close to the viewfinder the microdisplay-based viewfinder automatically turns on. This handset of FIG. 3A through FIG. 3C would automatically turn on the microdisplay only when the handset is displaying a high-resolution image and when the sensor senses that the user's eye is close enough to the microdisplay—within three inches or so. At all other times, the handset would automatically turn the microdisplay off, saving considerable power relative to a device that leaves the microdisplay on all the time or one that leaves it on even when the user's eye is not close to the microdisplay. This method of automatically turning the microdisplay on and off can also be used with the previous embodiments described above. As used herein, the phrase “turn the microdisplay off” means to deactivate the microdisplay (or to put it in an “idle” state) such that it is not generating images or generating light that would prevent the correct operation of the direct-view display. It does not necessarily mean that no power is being supplied to the microdisplay. However, the result of turning the microdisplay off (or putting it in an idle mode) will typically be substantial power savings.

This handset of FIG. 3A through FIG. 3C can also be built less tall than handsets that separate the two displays (as in FIG. 1A through FIG. 1C), since the two displays overlap one another in this design, although it could make the phones a bit thicker when viewed from the side.

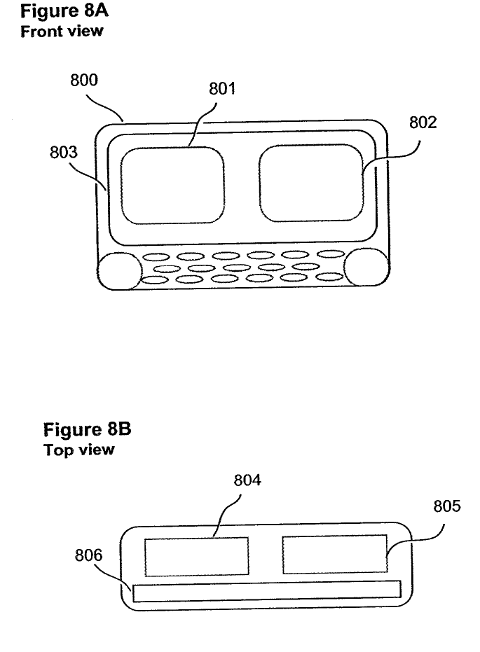

An interesting expansion on this concept is illustrated in FIG. 8A (front view) and FIG. 8B (top view). The device 800 in FIG. 8A includes a large direct-view display 803 and two embedded microdisplays 801 and 802. In the top view FIG. 8B, the front of the device is shown facing down, and the direct-view display 806 is shown in front of the two microdisplays 804 and 805. The direct-view display overlaps both microdisplays. The direct-view display is capable of becoming transparent, similar to the direct-view display discussed in relation to FIG. 3 above. The microdisplays would be spaced far enough apart so that, when the device is brought near-to-eye (and perhaps rotated 90-degrees), the user can look into the two microdisplays—the left eye in front of the left microdisplay and the right eye in front of the right microdisplay—similar to the way users look into the binocular microdisplays in wearable displays such as Inviso Inc.'s “eShades” product. Each microdisplay could display the same image. Or the device two could display a 3D stereoscopic image by displaying a 3D scene on the left microdisplay from a perspective that is slightly to the left of the perspective used for the right microdisplay—a common technique for displaying stereoscopic 3D images on wearable binocular displays. This is particularly compelling when displaying 3D games or videos.

As with the earlier “monocular” example, the direct-view display could go clear automatically (using a distance sensor) or manually (by the user pressing a button) when the user brings the device near-to-eye, and the microdisplays could turn on then. When the device is not near-to-eye, the microdisplays would be off, and the direct-view display would be used to display content. In a preferred embodiment, text and other images drawn on the direct-view display would be oriented so that the long side of the direct-view display runs horizontally—so that the user does not have to rotate the device when transitioning between arms'-length viewing of the direct-view display and near-to-eye viewing of the side-by-side microdisplays. In a preferred embodiment the distance between the microdisplays would be adjustable, but an alternative is to separate the two microdisplays by a distance that is comfortable for the average targeted user of the device.

A handset could also be designed with a direct-view display on one side of the handset (such as the front) and a microdisplay on the other side of the handset (such as the back). But this would require users to turn the handset over when switching between viewing the direct-view display and viewing the microdisplay—which is more awkward than simply bringing the handset to the eye to view an image in the microdisplay.

In addition to the direct-view display and the microdisplay described in the above embodiments, phones using this invention can include one or more extra direct-view displays. One reason to include an extra direct-view display would be to put a small direct-view display on the top of the phone (or on the back of one part of a flip phone) so that a user could see caller-ID, time, or other information even when the phone is in a holster on the user's belt (or, in the case of the flip-phone, even when the phone is closed).

On any of these dual-display devices, either or both of the displays could be touch sensitive (like many PDAs today), allowing users to input data and control aspects of the device by moving their fingers, a pen, or a stylus across the touch-sensitive area of the display(s).

Each of the handsets illustrated in FIG. 1A through FIG. 3C is shown with three side-buttons on the right side—“Shift”, “2nd Letter”, and “3rd Letter” side-buttons—which a user can press with the hand holding the phone while simultaneously using the other hand to type the handset's face-keys. For example, to type the lowercase letter “m”, the user would just type the “6” key. To type the uppercase letter “M”, the user would type the “6” key while holding in the “Shift” side-button. To type the lower-case letter “u”, the user would type the “8” key while holding in the “2nd Letter” side-button. To type the upper-case letter “U”, the user would type the “8” key while holding in both the “Shift” side-button and the “2nd Letter” side-button. This can allow for faster text-typing than on current cell phones and PDAs. This is important for typing-intensive applications and functions such as instant messaging, email, interacting with some Web pages, and other applications that involve entering information into forms or documents. That fast-typing-enabling invention is the subject of patent application Ser. No. ______, assigned to the common assignee and incorporated herein by reference.

The device can also include a roller control 102 of FIG. 1B which, when rolled in one direction, changes the highlighting in a displayed list of selectable items from the currently highlighted item to the next selectable item; and, when rolled in the other direction, changes the highlighting from the currently highlighted item to the previous selectable item. Selectable items can include fields on a form, fields on a Web-page form (such as radio buttons, check boxes, menu items, editable text fields, and so on), links on a web-page, selectable images on a web-page, commands defined by software on the handset (such as a home-page icon always visible on the edge of a Web-browser application), or any other visual items the developer chooses to make selectable. This is similar to using the Tab-forward and Tab-back keys on a Windows PC to move the highlighted item on a Web-page, dialog or other document—often called the “focus” by programmers—from one selectable item to the next one or to the previous one. Note the “list” of selectable items does not have to appear linear: A web-page has a “list” of selectable items, as seen in the Web-page's HTML, even if those items are arranged nonlinearly in a two-dimensional design. In fact, a “selectable” item can be any displayed item that can either be selected or, in the case of a text-entry box, typed into. The control can also be used to select items that are displayed by the handset itself (such as the list of functions available on the phone device) as well as applying to items that appear on Web pages and other documents displayed. In all these cases, a roller control can also be used to traverse through lists of items and to select items. The roller control 102 can also be pressed to select the highlighted item in any displayed list of items.

In another embodiment of my invention, seen in FIG. 4, the device includes a button 401 that, when pressed briefly, changes the highlighting in a displayed list of selectable items from one selectable item to the previous one. The device can also include a button 403 that, when pressed briefly, changes the highlighted item in a displayed list of selectable items from one selectable item to the next one. These buttons 401 and 403 can be labeled Tab-backward and Tab-forward, or labeled with the Tab symbols used on Tab-forward and Tab-backward keys on many computer keyboards—an arrow pointing to a short vertical line. These buttons can be placed anywhere on the device. The device can also include a button 402 that, when pressed, selects the highlighted item in the displayed list of items. This button can be labeled “enter”. These buttons do not have to be configured as buttons 401, 402, and 403 appearing in FIG. 4: They could be configured as arrow keys and other buttons elsewhere on the device—such as the arrows and enter buttons 113 on FIG. 1B.

As additional examples of operation of the above buttons, when the button 401 (or 403) of FIG. 4 is pressed and held for more than a defined period of time (for example, more than 0.5 second), then instead of the highlighting moving from one selectable item to the previous (or next) item just once, the highlighting moves to the previous (or next) selectable item, stays briefly (e. g. 0.25 sec), moves to the previous-to-the-previous (or next-to-the-next) selectable item, stays briefly, and continues moving back (or forward) through the list of selectable items for as long as the user continues holding the corresponding button 401 (or 403). This is simply an alternative to continuously rolling the roller control outlined above to quickly move the highlighting hack and forth through the list of selectable items.

The device can also be designed such that the longer the button 401 or 403 is held, the faster the highlighting moves through the list of selectable items, up to some maximum speed (and with the speed accelerating in well defined increments from relatively slow to relatively fast).

As noted above, a device can include tab-forward and tab-backwards buttons with which the user can move the focus forward or backward through a list of selectable items. These tab-forward and tab-backward buttons can be connected under a toggle control (sometimes called a rocker switch), so that a user can tab the focus forward or backward among the selectable items by rocking their thumb (or other finger) back and forth on the toggle button.

In addition, pressure-sensitive switches can be used for the tab-forward and tab-backward buttons: When a user lightly presses the tab-forward button (or the tab-backward button), the focus would scroll slowly forward (or backward) through the selectable items (for example, pausing one second on each item); and when the user presses the tab-forward (or tab-backward) button harder, the focus would scroll more quickly forward (or backward) through the selectable items. A simple dual-pressure switch can be used for each of the tab buttons—allowing the user to tab forward or backward slowly or quickly. Or controls that are sensitive to more levels of pressure or positions of pressure can be used to allow more than two speeds of movement of the focus in each direction. In this document, we will refer to any control or button that can cause a function or visual element to move at more than one speed as “multi-speed”. Note that a device with these pressure-sensitive tab controls can be used to tab through selectable items on Web pages or other documents displayed on any display associated with the device—which could be a display embedded or attached to the device, or it could be a remote display (such as a TV set displaying a Web page, with the device operating as a kind of remote control).

These controls or buttons for efficiently moving the focus backward and forward through the selectable items are particularly convenient when viewing a Web page on a device held near-to-eye, since using a cursor control to move a cursor to a specific spot on a large virtual image on a microdisplay can be somewhat awkward while holding a device near-to-eye. But as anyone who uses a mouse on a desktop computer knows, a cursor control is still quite useful for many operations. A cursor control would let a user move a cursor in multiple directions (ideally in 360-degrees) over an image shown on the microdisplay. (A pressure-sensitive or displacement-sensitive cursor control can be used to allow the user to move the cursor at multiple speeds—e.g. slowly or quickly.) And as noted earlier, it is also convenient to include a “menu” button, to allow users to quickly bring up lists of options available in a given context: The user can then move the focus among the options in the menu using the Tab-forward and Tab-backward buttons, and select one of the options using the “Enter” button. So a preferred embodiment would include (as shown on FIG. 5) a multi-speed cursor control 501, a Menu button 502, an Enter button 503, and a pressure-sensitive tab-backward/tab-forward toggle switch 504. In this preferred embodiment, the cursor control, tab buttons, menu button and enter button would all be positioned just above the keypad and below the displays where they can all be operated using the thumb of the hand holding the device. FIG. 5 shows one good configuration, with a microdisplay 505 near the top of the phone, and a direct view display 506 below the microdisplay and above the cursor control 501. These buttons and controls could have different positions, shapes and names while still conforming the principals outlined here.

This combination of buttons and controls is useful on hand-held devices with embedded microdisplays, on hand-held devices with attached microdisplays (e.g. where the microdisplay is in a detachable component), as well as on hand-held devices that display content on a wearable display (where the wearable display includes one or more near-to-eye microdisplays, and where the wearable display is connected to the device by a cable or by a wireless connection).

An alternative embodiment could include these buttons and controls on one side of the device or both sides of the device, instead of on the face of the device. The inventor prefers placement on the face of the device (rather than placing them all on one side of the device) so that either hand can operate these buttons and controls while holding the device.

Note that this combination of buttons and controls would be useful for interacting with Web pages and other content on any device, whether or not the device includes a microdisplay. In particular, for many applications it is convenient to have a multi-speed cursor control (one that can move the cursor at more than one speed). One preferred type of multi-speed cursor control is a pressure-sensitive cursor control, with which the speed at which a cursor moves corresponds to the amount of force the user uses when pushing the cursor control in the direction the user wants to move the cursor. For example, with a flat cursor control pad, pressing the cursor control on the top edge of the cursor control moves the cursor up; pressing hard makes it move up quickly, and pressing lightly makes it move up slowly. As another example, if the cursor control is in the shape of a stick, pressing the stick hard to toward the upper right corner of the device makes the cursor move that direction quickly, and pressing the stick lightly in that direction makes the cursor move slowly in that direction.

An alternative type of multi-speed cursor control is one in which the cursor control can detect where the user touches it, within a defined area, and the further from that area's center that one presses the cursor control, the faster the cursor moves in the direction defined by the line between the center of the cursor control and the point at which the cursor control was pressed. We will refer to this as an “offset-sensitive multi-speed cursor control”.

The handsets if FIGS. 1B, 1C, 2B, 2C, 3B and 3C are also shown illustrated with three extra face-buttons, below the main dialing keys, which allow users to type 18 additional characters (when the Shift, 2nd Letter, and 3rd Letter side-buttons are used simultaneously). The extra characters in these handsets are:

−(:)+−=%″′[;]˜₋ˆ <\>

A device with both a microdisplay and a direct-view display built according to the present invention can be combined with the above fast-typing-enabling invention and with a rich set of character keys, to make devices that are especially compelling to users who want exceptional display capabilities and exceptional input capabilities in a single pocket-sized device. Different handsets can have different character sets and different types of side-buttons, while adhering to these inventions.

Also, devices can be made that have detachable microdisplay modules: A user could choose to only attach the microdisplay module when they want to view relatively high-resolution or large content.

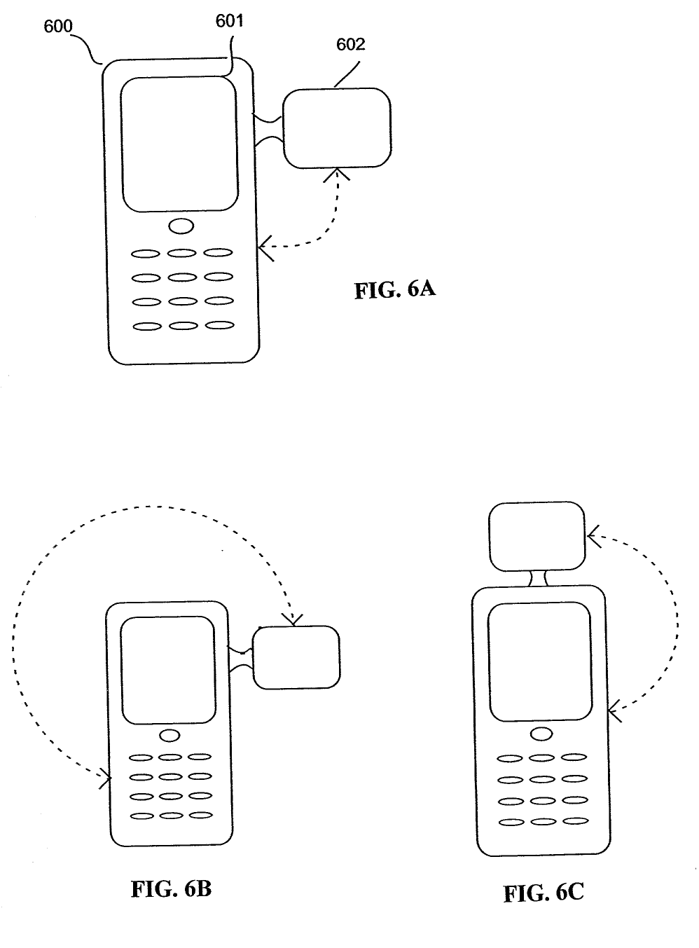

In addition to the embodiments discussed above, embodiments of this invention can include a microdisplay that, when not in use, folds into the body of the device out of view, as shown in FIGS. 6a and 6b. The microdisplay 602 would be mounted on an arm. When the user wants to use the microdisplay, they can then pop the microdisplay out and swing it around on the arm to position the microdisplay to the left, to the right, or above the top of the device. FIG. 6a shows a microdisplay 602 swung up 90-degrees from the right side of the device 600, which has a direct-view display 601 on its face. When the microdisplay were not in use, the user could swing it back into the device and it would not be visible from the front of the device.

When the microdisplay 602 is placed to the left or to the right of the direct-view display, then the direct-view display 601 can act as an occluder by turning the direct-view display off (or having it display a neutral color such as medium or dark grey, for example) when the user is using the microdisplay 602 with one eye, so that the user can use the direct-view display to block the other eye (which allows the user to more comfortably keep that other eye open as discussed earlier).

One embodiment using this concept would operate like some “opera glasses”, allowing the microdisplay to swing out from one side of the device (e.g. the left side) on an arm that pivots near the top of the device, rotating 270-degrees until the arm sticks horizontally out of the other side of the device (e.g. the right side). FIG. 6b shows an example: The microdisplay swings out from the left side of the device, up and around 270-degrees to its usable position just to the right of the direct view display.

Another embodiment using this concept would allow the microdisplay to swing out of one side of the device on an arm that pivots near the top of the device, rotating substantially 180-degrees until the arm sticks vertically out of the top of the device. FIG. 6c shows an example.

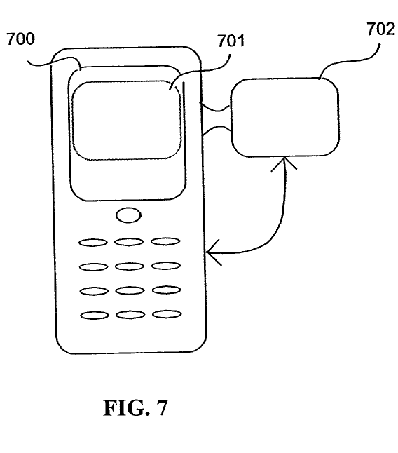

A variation of this fold-out-microdisplay concept is to include two microdisplays in the device as shown in FIG. 7—one microdisplay 701 that is covered by the direct-view display 700, and a second microdisplay 702 that folds out of the body of the device. When the user brings the device near-to-eye, the direct-view display 700 would become transparent (as discussed above in the earlier discussion of FIG. 3) and the user can look through the transparent direct-view display into the first microdisplay. The user could simultaneously look into the second microdisplay with their other eye. Thus the user would be looking into two microdisplays simultaneously, one for each eye—as occurs when users look into wearable binocular displays such as Inviso Inc.'s eShades product. Each microdisplay could display the same image, or the two displays could be used to display a stereoscopic 3D image (with the left microdisplay displaying a 3D scene from a perspective slightly to the left of the perspective displayed by the right microdisplay.) This is particularly compelling when displaying 3D games or videos.

Another embodiment involving two microdisplays would be to put both microdisplays on the swinging arm, much like opera glasses. When not in use, the two microdisplays would be folded into the body of the device. To use them, the user would swing out the arm on which the pair of microdisplays is mounted, positioning so that the user can peer into the pair of microdisplays with both eyes. In a preferred embodiment, the distance between the microdisplays could be adjusted. In a simpler embodiment, they would be fixed at a distance that accommodates the average distance between pupils for the intended target group. In a preferred embodiment, the pair of microdisplays would pivot on the arm so as to stick out approximately horizontally from the body of the device when in use.

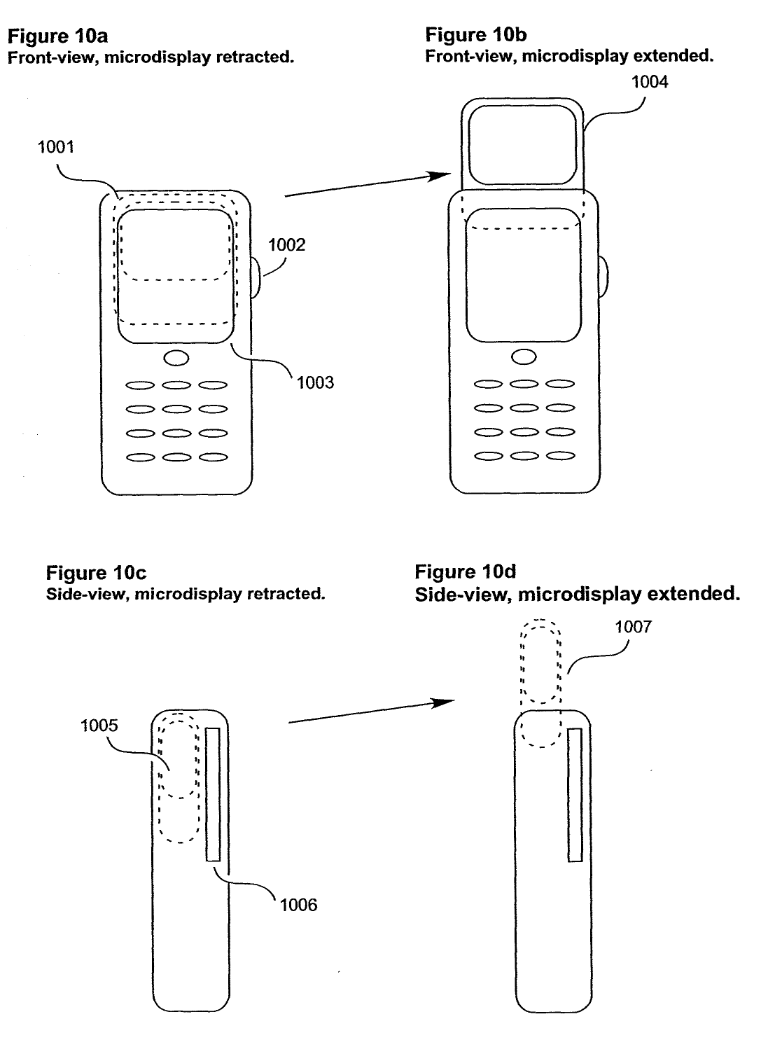

Earlier we discussed embodiments that involve a microdisplay that folds into the body of the device when not in use and that swings out on an arm when the user wants to use it. An alternative embodiment is a device with a microdisplay module that slides straight out when the user wants to use it, and that can slide into the body of the device when not in use. When extended, the microdisplay module would remain attached to the body of the device, but would be extended far enough for the user to look into the view window of the microdisplay module to see the image displayed on the microdisplay. When retracted, the view window would be hidden within the body of the device. In a preferred embodiment, the microdisplay would slide out of the top of the device, so that, when in use, the microdisplay would be positioned above the rest of the device. Alternatively, the microdisplay can slide out of the side of the device or slide out of the bottom of the device. A device implemented according to this embodiment could be called a device with a “slide-out” microdisplay, or a device with a “pop-out” microdisplay. If the microdisplay slides out of the top of the device, it could be called a device with a “pop-up” microdisplay. FIG. 10A shows a front view of a device with a microdisplay 1001 that is slide into the body of the device while not in use. (The microdisplay 1001 is shown as dotted lines because it is hidden inside the device when not in use.) The device will typically include a direct-view display 1003 on its face, but a device with a slide-out microdisplay does not necessarily have to include a direct-view display. FIG. 10B shows a front view of the device with the microdisplay 1004 extended for use. In this example the microdisplay slides out of the top of the device. FIG. 10C shows a side view of the device with the microdisplay 1005 retracted when not in use, as well as a direct-view display 1006 on the face of the device. FIG. 10D shows a side view of the device with the microdisplay 1007 extended.

A device with a slide-out microdisplay can also include a button that the user can push to make the microdisplay slide out. FIG. 10A shows an example of this button 1002 on the side of the device. The button could appear anywhere on the device. In a preferred embodiment, pushing the button would result in a microdisplay popping up out of the top of the device on a spring-loaded sliding mechanism, extending completely; and when the user is done using the display, they could press the microdisplay back into the device, and when it has been pushed all the way down into the device it would stay there until needed again.

Any of the above embodiments would also benefit from including a light sensor for measuring the level of ambient light and using the information from this light sensor to automatically adjust the brightness level and amount of power used by the direct-view display. Software or firmware on the device can use the information from this light sensor to automatically optimize the appearance of the display in various lighting conditions while minimizing the power used by the direct-view display. Some types of direct-view displays, such as OLEDs, require more power to make them bright enough to see in bright environments such as outdoor sunshine; other types of direct-view displays, such as reflective and transflective TFT displays, can use less power in bright light environments such as outdoor sunshine but require more power to make them bright enough to be seen in dark environments. The software or firmware would adjust the power and brightness levels accordingly, depending on the type of display.

For some languages, such as Chinese, some users find it more convenient to write characters on a touch pad, using their finger or using a stylus, than to type characters using a device's buttons. Touchpads can also be used to aid in navigation and control of the device. Therefore, one useful embodiment of this invention is a device with a touchpad and at least one microdisplay and at least one direct-view display.

A particularly useful embodiment of this invention is a device with a Global Positioning System (GPS) or assisted-GPS receiver built in, in addition to an embedded or attached microdisplay and a direct-view display. On a device with a microdisplay, users can see larger higher-resolution images than they can see on today's direct-view displays that are small enough to fit on a pocket-size device—particularly when the microdisplay is high resolution like Inviso's SVGA (800×600 pixel) displays. Therefore, users could see detailed maps on a microdisplay. With a GPS receiver built into a microdisplay-enhanced device, the device could display detailed maps showing the user's current location—and, with appropriate software, display moving maps as the user moves. And if the device also includes a direct-view display, the user would not have to hold the device near-to-eye continuously to read the map. Users can periodically briefly bring the device near-to-eye to orient themselves by viewing a large section of the map on the microdisplay while most of the time holding the device at arms'-length and viewing the smaller region of the map that contains the user's current location (determined by the GPS receiver) on the direct-view display. This illustrates a key benefit of this invention: The ability to “get the big picture” and “get oriented” using the microdisplay when needed, without the burden of having to hold the device near-to-eye all of the time, while retaining an ability to stay oriented using the direct-view display. This principal works well for Web pages, email, and other documents, as well as maps.

In fact, a device maker could choose to include a button on the device that user can press to make the device immediately fetch a map (either from local memory or, in the case of a wireless device, from a remote source) showing the user's location (using location data from the GPS receiver). Then the user can view the map on the microdisplay, or view a smaller portion of the map on the device's main direct-view display.

A more general form of this idea is to include a Home button on the device that the user can press to bring up a Web page that the user (or a service provider) has previously designated as the user's Home Page—such as a My Yahoo page that shows a lot of consolidated information that the user likes to check several times a day (like whether, stocks, news, sport scores, and so on). Our invention makes viewing and interacting with these kinds of complex Web pages on pocket size devices feasible and enjoyable.

A device maker can choose to include a light on the device (preferably on the face of the device) that lights up only when the device has a Web page or other high-resolution content to display on the microdisplay. For example, suppose a user invokes a function on a microdisplay-enhanced, Internet-enabled phone to instruct the phone to fetch a Web page. It might take a minute for the phone to download and render the page. The light could remain off (or it could flash steadily) until the page has been fetched and rendered, and then the light could light up (or stop flashing and remain steadily on as long as the content remains available for display). The steady light would let the user know that they can see the new content by bringing the device near-to-eye and looking into the microdisplay.

In preferred embodiments of this invention, the microdisplays would have at least 800 horizontal pixels and at least 600 vertical pixels. This is wide enough to view standard Web pages. Also, in preferred embodiments, each microdisplay pixel could be any of at least 256 colors—where the term “colors” is used generically here, so they all could be shades of gray or they could include non-gray colors. Ideally, the microdisplay could display more than 256 distinct colors, but 256 is minimally sufficient to display a wide range of images reasonably well.

While the foregoing has been with reference to particular embodiments of the invention, it will be appreciated by those skilled in the art that changes in these embodiments may be made without departing from the principles and spirit of the invention, the scope of which is defined by the appended claims.

I claim:

1. A hand-held phone handset or other hand-held device having a face, said face having two or more displays for displaying images, wherein at least two of said displays are in the same line of sight.

2. The device of claim 1 in which at least one display is a direct-view display.

3. The device of claim 1 in which at least one of the displays is a microdisplay.

4. The device of claim 1 in which the device has exactly two displays.

5. The device of claim 1 in which the device has one direct-view display and one microdisplay in the same line of sight.

6. A hand-held phone handset or other hand-held device having a direct-view display on one part of the device, said one part connected by a hinge to a second part of the device, said second part including a microdisplay and a keypad, wherein said microdisplay is positioned between said hinge and said keypad.

7. A hand-held phone handset or other hand-held device having a face, said face having a microdisplay, a direct-view display and a keypad, wherein said microdisplay is positioned above said direct-view display on said face, and wherein said keypad is positioned below said direct-view display on said face.

8. The device of claim 1 in which the device includes a roller control which, (a) when rolled in one direction changes the highlighting in a displayed list of selectable items from the currently highlighted item to the next selectable item, and (b) when rolled in the other direction changes the highlighting from the currently highlighted item to the previous selectable item.

9. The device of claim 8 in which the roller control can also be pressed to select the highlighted item in any displayed list of items.

10. The device of claim 8 in which the list of selectable items includes selectable items defined by a Web-page's HTML.

11. The device of claim 8 in which the selectable items are arranged nonlinearly in a two-dimensional array.

12. The device of claim 8 wherein the selectable items can be any displayed item that can either be selected or typed into.

13. The device of claim 8 in which the selectable items are part of Web pages and other documents, as well as items that are defined by the handset itself.

14. The device of claim 8 wherein the selectable items are a list of functions available on the cell phone handset at a given time.

15. The device of claim 1 in which the device includes a first button that, when depressed briefly, changes the highlighting in a displayed list of selectable items from one selectable item to the previous selectable item; and in which the device also includes a second button that, when depressed briefly, changes the highlighted item in a displayed list of selectable items from one selectable item to the next selectable item.

16. The device of claim 15 in which the device also includes a button that, when depressed, selects the highlighted item in the displayed list of items.

17. The device of claim 15 in which said first button and said second button are configured as a single toggle control.

18. The device of claim 15 in which, when said first button is depressed and held for more than a predetermined period of time, instead of the highlighting moving from one selectable item to the previous selectable item only one time, the highlighting moves from one selectable item to the previous selectable item, pauses briefly, moves from said previous selectable item to the next-previous selectable item, pauses briefly, and continues moving back through the list of previous selectable items serially for as long as the user continues holding said first button in a depressed condition.

19. The device of claim 15 in which, when said second button is depressed and held for more than a predetermined period of time, instead of the highlighting moving from one selectable item to the next selectable item only one time, the highlighting moves from one selectable item to the next selectable item, pauses briefly, moves from said next selectable item to the next-next selectable item, pauses briefly, and continues moving forward through the list of next selectable items serially for as long as the user continues holding said second button in a depressed condition.

20. The device of claims 18 or 19 in which the longer said first or second buttons is held, the faster the highlighting moves through the list of selectable items, up to some maximum speed.

21. The device of claims 18 or 19 in which said first button or second button is pressure sensitive, and the harder said first or second buttons is pressed, the faster the highlighting moves through the list of selectable items, up to some maximum speed.

22. The device of claim 20 or claim 21 in which said speed accelerates in well-defined increments from relatively slow to relatively fast.

23. The device of claim 1 in which one or more of the displays is also a touch-screen display that a user can use to control or enter input into the device.

24. The device of claim 1 in which the device also includes multiple face-keys and one or more side-buttons wherein a user can type a character or invoke a function by depressing one of the face-keys using a finger on the hand that is not holding the device while simultaneously depressing combinations of the side-buttons with fingers on the hand that is holding the device.

25. The device of claim 24 in which depressing a face-key without holding in any of the side-buttons generates a given character or function, while depressing the same face-key while simultaneously holding in a given combination of the side-buttons can generate a different character or function.

26. The device of claim 24 in which depressing a given face-key or button on the device, or depressing a combination of one or more face-keys or buttons on the device, results in the device popping up and displaying on one or more of said displays a menu in a menu bar and highlights a menu item in said menu.

27. The device of claim 26 wherein the highlighted menu item is the top item in said menu.

28. The device of claim 26 further having left and right keys or left and right sides of a cursor control, wherein further depressing one of said left or right keys or one of said left or right side of said cursor control results in closing the currently popped-up menu and popping up the previous or next menu in said menu bar and highlighting an item on said menu.

29. The device of claim 28 wherein the highlighted item is the top menu item in said menu.

30. The device of claim 28 further having up and down keys or top and bottom sides of a cursor control, wherein further depressing one of said up or down keys or one of said top or bottom sides of a cursor control highlights the next or previous menu item in the currently popped up menu.

31. The device of claim 26 further including an “enter” button or a “select” button and depressing said “enter” or “select” button results in the highlighted menu item being selected.

32. The device of claim 1 further including speech recognition software, said speech recognition software enabling use of spoken commands to pop up and traverse menus or to select menu items or to select other selectable items displayed on at least one of said two or more displays.

33. The device of claim 32 further including a push-to-talk button, in which the device's speech recognition features are enabled only when the user holds in said push-to-talk button on the device.

34. The device of claim 32 wherein said push-to-talk button is on the side of the device in a location in which said push to talk button can be depressed with a finger or thumb on the hand holding the device.

35. A hand-held phone handset, hand-held computer, or PDA, having one or more embedded or attached microdisplays and further including a distance sensor, said distance sensor causing said one or more microdisplays to be activated only when said distance sensor senses that an object is within a predetermined distance from said one or more microdisplays.

36. The device of claim 35 in which the device displays a default message or image on said one or more microdisplays if the user places said one or more microdisplays near his or her eye when the device does not have any other content to display on said one or more microdisplays at the moment.

37. The device of claim 35 in which the said one or more microdisplays are activated only when (a) the device has performed a function that results in a Web page or other relatively large and high-resolution image being prepared for display on the said one or more microdisplays, and (b) the distance sensor senses that an object is close to the said one or more microdisplays.

38. The device of claim 3 in which the device also includes a retinal scanner and software for identifying whether the retina of an eye looking into the scanner is the eye of someone authorized to use the device or one or more of the functions accessible via the device.

39. The device of claim 5 in which the direct-view display covers the microdisplay and in which the direct-view display can be made substantially transparent such that when the microdisplay is activated the user can see through the direct-view display to see the image on the microdisplay.

40. The device of claim 39 in which the device also includes at least one button depressible by the user to make the direct-view display substantially transparent and to activate the microdisplay.

41. The device of claim 40 wherein the device is capable of displaying text or images for device functions and (1) when the user depresses one of said at least one depressible buttons once the direct-view display becomes substantially transparent and the microdisplay is activated, and (2) when the user depresses at least one of said depressible buttons again, or depresses another of said at least one depressible buttons, the microdisplay is deactivated and the direct-view display returns to displaying any appropriate ones of said text or images for the current function.

42. The device of claim 40 wherein the direct-view display becomes clear and the microdisplay is activated only while one of said at least one depressible buttons remains depressed.

43. The device of claim 42 wherein when said one of said at least one depressible button is released, the microdisplay is deactivated and the direct-view display returns to displaying any appropriate of said text or images for the current function.

44. The device of claim 39 in which the device also includes a distance sensor and in which the direct-view display becomes substantially transparent and the microdisplay is activated only when the sensor senses that an object is within a predetermined distance from the microdisplay.

45. The device of claim 39 wherein the device is less tall than it would be if the displays were placed one above the other.

46. The device of claim 5 in which the microdisplay is in its own detachable module.

47. The device of claim 5 wherein the microdisplay is placed near the top of the handset and the direct-view display is placed near the middle of the handset.

48. The device of claim 47 further including a keypad placed below the direct-view display.

49. The device of claim 5 wherein the microdisplay is on the back of the device and the direct-view display is on the front of the device.

50. The device of claim 5 wherein both displays are touch sensitive displays.

51. A hand-held device having thereon a direct-view display located adjacent to a microdisplay.

52. The device of claim 51 that is a non-folding device with a microdisplay above and adjacent a direct-view display.

53. The device of claim 51 that is a non-folding device with a microdisplay below and adjacent a direct-view device.

54. The device of claim 51 that is a folding device having folded and unfolded positions, wherein when the phone is in its unfolded position the direct-view display is above the microdisplay.

55. The device of claim 51 that is a folding device having folded and unfolded positions, wherein when the phone is in its unfolded position the direct view display is below the microdisplay.

56. The device of claim 51 having a second direct-view display.

57. A hand-held phone handset or other hand-held device having at least one direct-view display, at least one microdisplay and having a multi-speed cursor control to control the cursors on said displays.

58. The phone handset or other device of claim 57 wherein at least one of said microdisplays is embedded in the phone set or other device.

59. The phone handset or other device of claim 57 wherein at least one of said microdisplays is in a component detachably connected to said handset or other device.

60. The phone handset or other device of claim 57 wherein at least one of said microdisplays is a wearable display connected by cable or wirelessly to said phone set or other device.

61. The device of claim 57 wherein the cursor control is pressure sensitive or is an offset-sensitive multi-speed cursor control.

62. The device of claim 57 having a tab-forward button.

63. The device of claim 57 having a tab-backward button.

64. The device of claim 57 having tab-backward and tab-forward buttons structured as a single toggle control.

65. The device of claim 62, 63, or 64 wherein the tab buttons or tab toggle controls are multi-speed.

66. The device of claim 65 wherein the multi-speed tab buttons or controls are pressure-sensitive.

67. A hand-held phone handset or other hand-held device having a cursor control, and having a multi-speed tab-backward/tab-forward toggle control or multi-speed tab-forward and tab-backward buttons.

68. The device of claim 67 additionally having a Menu button.

69. The device of claim 67 additionally having an Enter button.

70. The device of claim 67 wherein the cursor control is multi-speed.

71. The device of claim 67 wherein the cursor control is a pressure-sensitive multi-speed cursor control.

72. The device of claim 67 wherein the cursor control is an offset-sensitive multi-speed cursor control.

73. The device of claim 67 additionally having a microdisplay module that can be attached or detached from the device.

74. A hand-held phone having at least one direct-view display on its face, and having a detachable microdisplay module.

75. The hand-held phone of claim 74 wherein said detachable microdisplay module attaches to the top of the phone.

76. The hand-held phone of claim 74 wherein the detachable microdisplay module attaches to the top-left edge of the phone.

77. The hand-held phone of claim 74 wherein the detachable microdisplay module attaches to the top right edge of the phone.

78. A hand-held phone or other hand-held device having at least one direct-view display, at least one microdisplay, and a touchpad.

79. The phone or other device of claim 78 wherein at least one of said at least one microdisplays is embedded in the phone or device.

80. The phone or other device of claim 78 wherein at least one of said at least one microdisplays is a detachable microdisplay.

81. A hand-held phone or other hand-held device having at least one direct-view display, at least one microdisplay, and having a GPS or assisted-GPS receiver.

82. The phone or other device of claim 81 wherein at least one of said at least one microdisplays is embedded in the phone or device.

83. The phone or other device of claim 81 wherein at least one of said at least one microdisplays is a detachable microdisplay.

84. A hand-held phone or other hand-held device having at least one direct-view display and exactly one embedded or detachable microdisplay module, wherein said embedded or detachable microdisplay module is embedded or attached near the top of the phone, and wherein the microdisplay module is tilted back slightly relative to the rest of the face of the device, allowing the user to look directly into the microdisplay while tilting the top of the phone slightly toward the user's forehead.

85. The device of claim 1 with one or more microdisplays, and with a light on the device that remains on while there is content ready for viewing on said one or more microdisplays, and wherein said light is turned off when there is not content ready for viewing on said one or more microdisplays.

86. The device of claim 85 wherein said light flashes on and off when said device is fetching and preparing a Web page or other content to be displayed on said one or more microdisplays.

87. The device of claim 1 with exactly one microdisplay, one or more direct-view displays, and an occluder.

88. The device of claim 87 wherein the occluder can also act as a cover for the microdisplay when the microdisplay is not being used.

89. The device of claim 88 with a means to detect when the cover is closed or open, and wherein the device will never turn the microdisplay on when the microdisplay's cover is closed.

90. The device of claim 1 having exactly one microdisplay with a cover useable as an occluder, further having one or more direct-view displays and a distance sensor, wherein when the distance sensor indicates that an object is within a predetermined distance from the device, then the device can automatically activate the microdisplay and automatically open the microdisplay cover, transforming the cover into an occluder.

91. The device of claim 90 wherein when the distance sensor indicates that the object is no longer within said predetermined distance, then the device can automatically deactivate the microdisplay and automatically close the microdisplay cover.

92. The device of claim 3 having at least one microdisplay with a cover useable as an occluder.

93. The device of claim 81, having a button that the user can depress to make the device fetch a map showing the user's current location and surroundings, wherein the user can then view the map on the microdisplay.

94. The device of claim 1, having one or more microdisplays and one or more direct-view displays, and further having a Home button that the user can depress to make the device fetch and display a previously designated Web page.

95. The device of claim 92 having a button operable by the user's thumb or other finger to allow the user to manually turn said at least one microdisplay on and off.

96. The device of claim 3 having
(a) a direct-view display on its face, said direct-view display capable of being rendered substantially transparent,
(b) two microdisplays located behind said direct-view display and viewable therethrough when said direct-view display is rendered transparent, said two microdisplays being spaced apart to be respectively viewable by the eyes of a user, and
(c) a distance sensor,
wherein when said device is brought near-to-eye said distance sensor causes said direct-view display to be rendered substantially transparent and said two microdisplays to be activated so as to be viewable through said direct-view display.

97. The device of claim 96 wherein the sensor also requires the device to be rotated substantially ninety degrees before said direct-view display is rendered substantially transparent and said two microdisplays are activated.

98. The device of claim 96 in which each of the two microdisplays displays the same image.

99. The device of claim 96 wherein the two microdisplays display a stereographic image by displaying a 3-dimensional scene on both microdisplays using a perspective for the left microdisplay that is slightly to the left of the perspective used for the right microdisplay.

100. The device of claim 96 wherein when the microdisplay is not activated by said distance sensor said direct-view display is used to display content including text and other images oriented so that the long side of the direct-view display runs horizontally.

101. The device of claim 96 wherein the distance between the two microdisplays is adjustable.

102. The device of claim 3 having at least two direct-view displays wherein one of said two direct-view displays is used to display content selected from the group consisting of caller-ID, or time.

103. The device of claim 102 in which said content displayed on said one of said two direct-view displays is viewable when the phone is in a holster.

104. The device of claim 102 wherein the said one of said two direct-view displays is located in a position taken from the collection of positions consisting of
(a) the face of the device;
(b) the top of the device;
(c) the back of the flippable portion of a flip style device;
(d) the side of the device.

105. The device of claim 3 having a microdisplay that folds into the body of the device.

106. The device of claim 105 wherein said microdisplay is mounted on a movable arm connected to said device by a pivot capable of being activated by a user, said arm enabling said mounted microdisplay to be quickly moved from a position within the body of said device to a position external to said device at which said mounted microdisplay is viewable by a user when said pivot is activated by a user.

107. The device of claim 106 in which said arm is swingably mounted to position said mounted microdisplay to the left, to the right or above the top of said device.

108. The device of claims 106 and 107 having a direct view device positioned on the face of said device capable of acting as an occluder when said direct-display device is turned off or made to display a neutral color and the user is viewing the mounted microdisplay with one eye.

109. The device of claim 107 wherein the swingably mounted arm swings out from one side of the device and rotates approximately 270-degrees until the arm protrudes approximately horizontally out of the other side of the device.

110. The device of claim 107 including (a) a second microdisplay, said second display located on the face of said device, (b) a distance sensor and (c) a direct-view display on the face in said device, said direct-view display capable of being rendered substantially transparent and being located behind said second microdisplay, wherein when a user brings said device near-to-eye the direct-view display is rendered substantially transparent and the user can look through the transparent direct-view display into said second microdisplay.

111. The device of claim 110 wherein when the swingably mounted arm positions the mounted microdisplay in a position at which a user can simultaneously look into the mounted microdisplay and the second microdisplay.

112. The device of claim 107 wherein two microdisplays are mounted on said swingably mounted arm, positioned so a user can look into one of said microdisplays with one eye while simultaneously looking into the other of said microdisplays with the other.

113. The device of claim 111 wherein the two microdisplays display a stereographic image by displaying a 3-dimensional scene on the left microdisplay from a perspective that is slightly to the left of the perspective used for the right microdisplay.

114. The device of claim 1 having at least one microdisplay and at least one direct-view display, said device further including a light sensor for measuring the level of ambient light, said device using said measured level to automatically adjust the brightness level and the amount of power used by the direct-view display.

115. The device of claim 114 including programming accepting codes representing said measured level and generating codes in response thereto, said generated codes used to automatically optimize the appearance of the direct-view display in various lighting conditions while minimizing the power used by said direct-view display.

116. The device of claim 10 wherein said selectable items further include items taken from the collection of items consisting of fields on a software application form, fields on a Web-page form, links on a Web-page, selectable images on a Web-page, and commands defined by software on the device.

117. The device of claim 116 wherein said Web-page forms further include items taken from the collection of items consisting of radio buttons, check boxes, menu items, and editable text fields.

118. The device of claim 116 wherein said commands include at least one home-page icon always visible on the edge of a Web-browser application.

119. The device of claim 10 wherein said selectable items include items that are displayed by the device itself.

120. A hand-held phone or other hand-held device having exactly one slidably mounted microdisplay module attached to said device, wherein said slidably mounted microdisplay module, when not in use, is positioned within the body of the device, substantially hiding the view window of said microdisplay module; and wherein said microdisplay module, when it is to be used, slides substantially straight out of the body of said device, remaining attached to said body of said device but extending out from said body of said device far enough for a user to look into said view window of said microdisplay module.

121. The device of claim 120 wherein said slidably mounted device is mounted at the top of said device.

122. The device of claim 120 wherein said slidably mounted device is mounted at the bottom of said device.

123. The device of claim 120 wherein said slidably mounted device is mounted at the side of said device.

124. The device of claim 120 wherein said slidably mounted microdisplay module is spring-loaded.

125. The device of claim 120 having a button wherein pressing said button while said slidably mounted microdisplay module is positioned within the body of the device results in the slidably mounted microdisplay module extending out of the device.

126. A hand-held phone handset or other hand-held device including a roller control which, (a) when rolled in one direction changes the highlighting in the selectable items defined by a Web-page's HTML from the currently highlighted item to the next selectable item, and (b) when rolled in the other direction changes the highlighting from the currently highlighted item to the previous selectable item.

127. The device of claim 126 in which the roller control can also be pressed to select the currently highlighted item.

128. The device of claim 126 in which said device includes one or two embedded or attached microdisplays, wherein said Web page is displayed on said microdisplays.

129. The device of claim 128 in which said device includes a direct-view display, wherein portions of said Web page are displayed on said direct-view display.

130. A hand-held phone handset or other hand-held device including two buttons and one or two embedded or attached microdisplays, wherein the microdisplays can display a Web-page whose HTML defines a list of selectable items, and wherein depressing the first of said buttons changes the highlighting in the said list of selectable items from the currently highlighted item to the next selectable item in said list, and depressing the second of said buttons changes the highlighting from the currently highlighted item to the previous selectable item.

131. A hand-held phone handset or other hand-held device having a first part and a second part, said parts connected by a hinge, wherein a microdisplay is located on said first part, and a direct-view display and a keypad are located on said second part, wherein said direct-view display is positioned between said hinge and said keypad.

132. A hand-held phone handset or other hand-held device having a face, said face having a microdisplay, a direct-view display, and a keypad, wherein said microdisplay is positioned below said direct-view display on said face, and wherein said keypad is positioned below said microdisplay on said face.

133. A hand-held phone handset or other hand-held device having at least one display for displaying selectable items on displayed Web pages, said device further including multi-speed tab-backward and tab-forward buttons each of said buttons actuable to two positions so that the user can actuate said buttons to (1) a first position to quickly tab backward or forward through selectable items on displayed Web pages or (2) a second position to slowly tab backward or forward through said selectable items on displayed Web pages.

134. A hand-held phone handset or other hand-held device having an associated display for displaying selectable items on displayed Web pages or documents, said device further including multi-speed tab-backward and tab-forward controls, each of said controls actuable to at least two pressure levels so that the user can actuate said buttons to tab backward or forward at varying speed through said selectable items, said speed being a function of the level of pressure applied by the user to said buttons.

135. A hand-held phone handset or other hand-held device with an embedded or detachable microdisplay, wherein said microdisplay has at least 800 horizontal pixels and at least 600 vertical pixels and wherein each pixel can be any of at least 256 colors.

136. A hand-held phone handset or other hand-held device having a first part and a second part, said parts connected by a hinge, said first part including a direct-view display and said second part including a microdisplay and a keypad.

137. The device of claim 1 including a distance sensor and in which at least one of said two or more displays is a microdisplay and at least one of said two or more displays is a direct-view display capable of being rendered transparent or a neutral color, said at least one microdisplay being located in a location taken from the collection of locations consisting of
(1) the main body of the device,
(2) the flippable portion of a flip-style device and
(3) behind and viewable through said at least one direct-view displays,
said distance sensor causing said at least one direct-view display to be rendered transparent or a neutral color and said at least one microdisplay to be activated only when the distance sensor senses that an object is within a predetermined distance from the microdisplay.
